(19) United States
(12) Patent Application Publication
(10) Pub. No.: US 2003/0179860 A1
(43) Pub. Date: Sep. 25, 2003

(54) Apparatus and method for recording meeting and/or teleconference

(75) Inventors: Bruce W.H. Sun, Taipei (TW); Chih Long Lin, Kaohsiung Hsien (TW)

Correspondence Address: BRUCE H. TROXELL, SUITE 1404, 5205 LEESBURG PIKE, FALLS CHURCH, VA, 22041, US

(73) Assignee: Multisuns Corp.

(21) Appl. No.: 10/102,822

(22) Filed: Mar. 22, 2002

(51) Int. Cl. H04M 1/64

(52) U.S. Cl. 379/67.1

(57) ABSTRACT

An apparatus for recording a meeting held in a room and/or teleconference comprises a signal receiving unit, a CODEC unit, a data processing unit, an input control unit, a storage unit, a speaker unit, a telephone unit, and a power source. A process for recording the meeting and/or teleconference comprises the steps of basic input control, state control, digital data processing, voice searching, echo attenuation, DTMF generation and receiving, voice processing, and file system management. With this, voice of an individual who is making a speech during the meeting and/or teleconference is located, amplified, and compressed prior to being recorded in a file of minutes. The minutes is integrated prior to storing in the storage unit in digital format so as to improve recording quality and facilitate reading and inquiry of the minutes.

### BACKGROUND OF THE INVENTION

1. Field of the Invention

The present invention relates to meeting recording devices and more particularly to an improved apparatus and method for recording either a meeting held in a room, teleconference, or both.

2. Description of Related Art

Conventionally, a recorder is used to record what was said in a meeting held in a room or teleconference. However, the recording quality is poor because echo was produced in the meeting room. Consequently, listening or speaking quality of each individual who participates in the meeting or teleconference is degraded. Hence, employment of the conventional recorder has an adverse effect on the recording quality. To the worse, a further utilization of the minutes is not available since there is no data integration thereon. Hence, a need exists for an apparatus and method for recording either a meeting held in a room and/or teleconference in order to overcome the above drawbacks of prior art.

### SUMMARY OF THE INVENTION

It is an object of the present invention to provide an apparatus and method for recording a meeting held in a room and/or teleconference having advantages of large memory for recording a large minutes, high-quality, user-friendly, and good listening and speaking environment. By utilizing this, the management and inquiry of minutes are more effective.

In one aspect of the present invention, in a meeting held in a room signal transmitted from a microphone associated with an individual who is making a speech is amplified. Then the amplified signal is used as a guide for searching a current voice source (i.e., the individual who is making a speech) of the meeting. Signal of the located voice source is amplified a predetermined number of times so as to improve a recording quality thereof.

In another aspect of the present invention, in a teleconference a telephone unit, a digital-to-analog converter (DAC), and corresponding processing steps are provided to communicate with a central office (CO) or a public branch exchange (PBX) so as to effect a two-way talking or multiple-way talking on the telephone, an echo attenuation in space and telephone, a good listening and speaking environment, and a data integration of minutes.

In still another aspect of the present invention, there is provided a storage unit for storing compressed voice data so that it is possible of recording a large minutes in a digital format for a long period of time.

In still another aspect of the present invention, there is provided an input control unit for user control signal input. Hence, direction adjustment, reading, and inquiry with respect to the recording are made convenient during the recording.

In yet another aspect of the present invention, there are provided a speaker unit, a digital-to-analog converter (DAC), and corresponding processing steps for user to listen voice data of the meeting and/or teleconference at any time.

In a further aspect of the present invention, there is provided a display unit for displaying operations in real time.

In still further aspect of the present invention, there is provided a wireless input control unit for user input instructions by wireless.

The above and other objects, features and advantages of the present invention will become apparent from the following detailed description taken with the accompanying drawings.

### BRIEF DESCRIPTION OF THE DRAWINGS

FIG. 1 is a block diagram of a first preferred embodiment of apparatus for recording meeting and/or teleconference according to the invention;

FIG. 2 is a flow chart illustrating a process for recording meeting and/or teleconference according to the first preferred embodiment of the invention;

FIG. 3 is a block diagram of a second preferred embodiment of apparatus for recording meeting and/or teleconference according to the invention;

FIG. 4 is a block diagram of a third preferred embodiment of apparatus for recording meeting and/or teleconference according to the invention;

FIG. 5 is a flow chart illustrating a process for recording meeting and/or teleconference according to the third preferred embodiment of the invention;

FIG. 6 is a block diagram of a fourth preferred embodiment of apparatus for recording meeting and/or teleconference according to the invention;

FIG. 7 is a flow chart illustrating a process for recording meeting and/or teleconference according to the fourth preferred embodiment of the invention; and

FIG. 8 is a block diagram of a fifth preferred embodiment of apparatus for recording meeting and/or teleconference according to the invention.

### DETAILED DESCRIPTION OF THE PREFERRED EMBODIMENTS

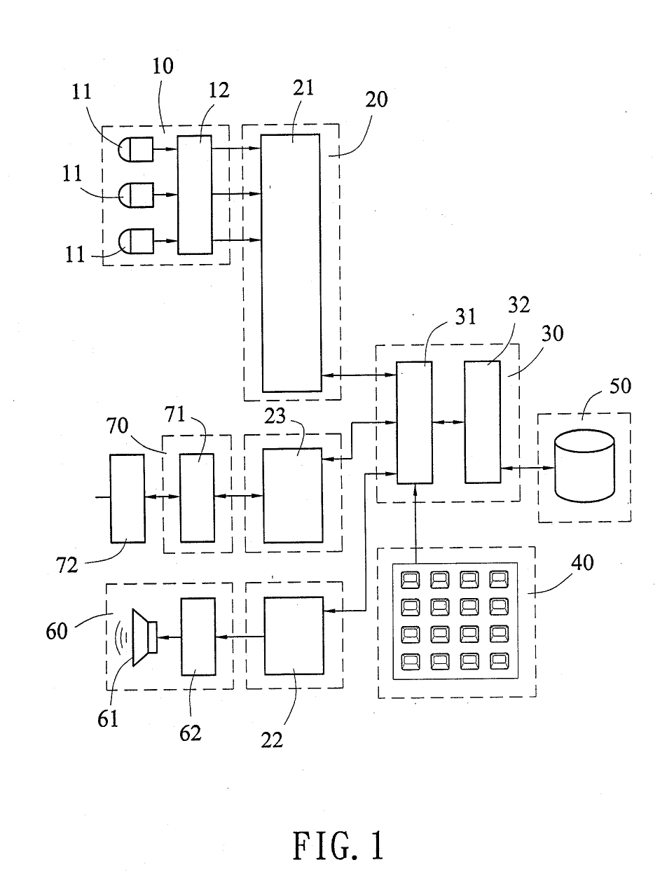

Referring to FIG. 1, there is shown a first preferred embodiment of apparatus for recording a meeting or a teleconference in accordance with the invention. Note that the meeting described herein means a meeting held in a room and the teleconference means one conducted over telephone or the Internet or videoconferencing. As shown, the apparatus comprises a signal receiving unit 10 including a plurality of coplanar microphones (three are shown) 11 for forming a wide signal receiving area and a signal amplifier 12 for amplifying signals transmitted from the microphones 11 wherein each of the microphones 11 is implemented as a capacitive or an inductive microphone; a data processing unit 30 including a logic control device 31 and a central processing device 32 wherein logic control device 31 is implemented as a field programmable gate array (FPGA) chip or other chip having the same capability for combining digital signals from peripheral devices into one for ease of control, and the central processing device 32 is responsible for data input/output (1/0) wherein the central processing device is implemented as one of digital signal processing (DSP) chip, Intel central processing unit (CPU) (e.g., 80×86 or Pentium series), micro-controller (8051, 8096, or Micron), and other chip for processing data I/O; a coder/decoder (CODEC) unit 20 including an analog-to-digital converter (ADC) 21 for converting analog signal received from microphones 11 into digital one, a digital-to-analog converter (DAC) 22 for converting digital signal sent from central processing device 32 into analog one, and a DAC/ADC 23 for converting digital signal sent from central processing device 32 into analog one or vice versa; an input control unit 40 implemented as a keypad for inputting control signal from user to the central processing device 32 so as to perform a direction adjustment; a recording, a reading, or an inquiry; a storage unit 50 implemented as a nonvolatile memory (e.g., floppy disk, read-only memory (ROM), CD-RW, DVD-RAM, erasable programmable ROM (EEPROM), Flash ROM, Compact Flash, Smart Media, Multimedia Card (MMC), Secure Digital (SD), Memory Stick, Memory Disk (MD), or other storage means) being controlled by the central processing device 32 in data I/O; a speaker unit 60 including a power amplifier 62 for amplifying signal outputted from DAC 22 and a speaker 61 for outputting the amplified sound volume for user listening; a telephone unit 70 including a telephone interface circuit 71 coupled to a central office (CO) 72 so that digital signals from the data processing unit 30 are converted into analog signals in DAC/ADC 23 prior to transmitting to CO 72 through telephone interface circuit 71, or analog signals from CO 72 are converted into digital signals in DAC/ADC 23 through telephone interface circuit 71 prior to transmitting to data processing unit 30; and a power source (not shown) for supplying a rated voltage to above components.

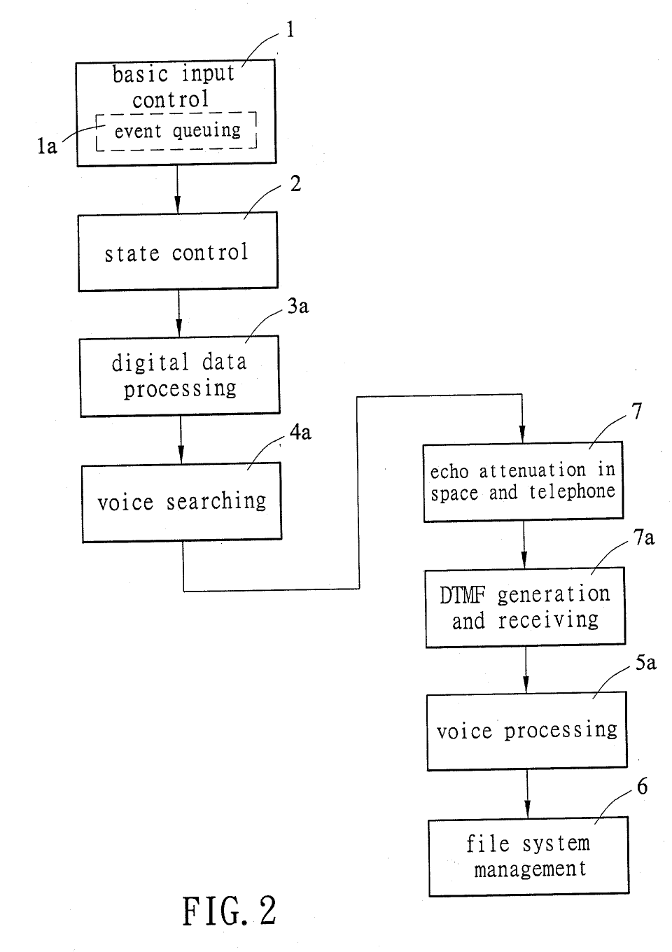

Referring to FIG. 2, there is shown a flow chart illustrating a process for recording meeting and/or teleconference according to the first preferred embodiment of the invention. The process comprises the following steps:

Step 1 of basic input control: It is responsible for receiving a control signal from the input control unit 40, queuing events in sub-step 1a, and converting the control signal into corresponding index of the event.

Step 2 of state control: It is responsible for converting a current state of the event into the other one based on the current state.

Step 3a of digital data processing is responsible for controlling data I/O and timing of the ADC 21, the DAC 22, and the DAC/ADC 23 so that voice quality can be further improved.

Step 4a of voice searching is responsible for receiving digital data from the signal receiving unit 10 and the CODEC unit 20, guiding the received data for searching a voice source of the signal receiving unit 10, synthesizing signals toward the voice source, amplifying the synthesized signal a predetermined number of times (three times in this preferred embodiment) and decreasing the other non-synthesized signals a predetermined number of times (three times in this preferred embodiment), and outputting the amplified signal to speaker unit 60 and DAC 22 via step 3a.

Step 7 of echo attenuation in space and telephone: It is responsible for receiving signal from either signal receiving unit 10 and DAC 22 or telephone unit 70 and DAC/ADC 23 via step 3a prior to attenuating the signal. The attenuated signal is sent back to step 3a.

Step 7a of dual-tone multifrequency (DTMF) generation and receiving: It is responsible for receiving signal from telephone unit 70 and DAC/ADC 23 via step 3a prior to determining whether the signal is a DTMF signal. If yes, the received command is sent back to step 2. Alternatively, control code generated in step 2 is received prior to generating DTMF signal. Further, created data is sent back to telephone unit 70 and DAC/ADC 23 via step 3a.

Step 5a of voice processing is responsible for receiving the amplified digital signal from step 3a and compressing the same, or alternatively, decompressing data sent from step 6a as commanded and sending the decompressed data back to step 3a. Note that a voice compression format can be selected from MP3, GSM 6.10, CELP 3.2a, MELP, ACELP, TRUE SPEECH, LPC 10e, ADPCM, ALAW, ULAW, or other applicable.

Step 6a of file system management is responsible for receiving the compressed signal, controlling an access to the compressed signal by the storage unit 50, and reading data from the storage unit 50 prior to sending the same back to step 5a. The file system is selected from FAT 12, FAT 16, Virtual FAT (VFAT), FAT 32, NT File System (NTFS), Ext 2 (Linux), or other applicable.

With this, voice of an individual who is making a speech during a meeting held in a room and/or teleconference can be easily located and amplified. Also, minutes recorded in files are compressed prior to storing in the storage unit. It not only improves recording quality but also facilitates reading and inquiry of the minutes by manipulating the input control unit since minutes are recorded in digital format in a large memory of the storage unit.

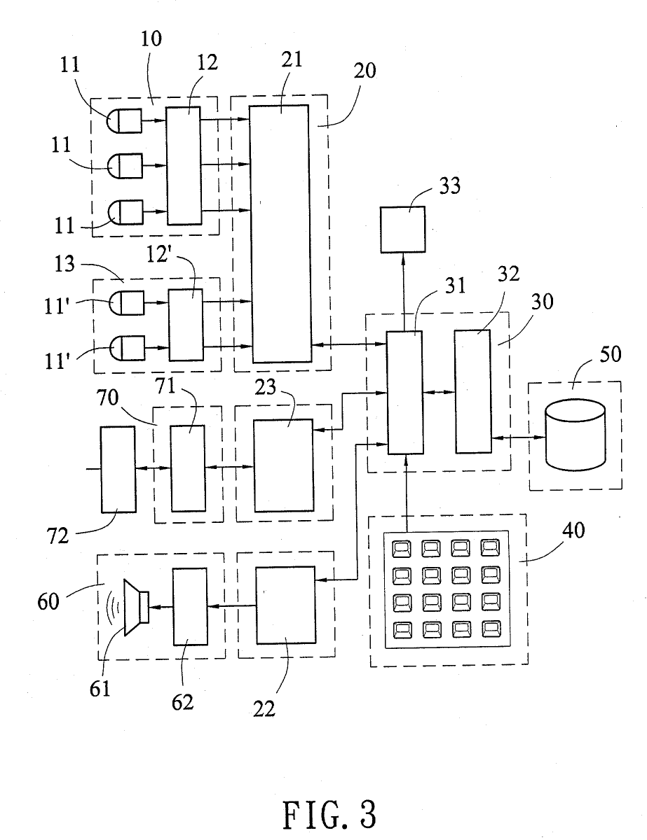

Referring to FIG. 3, there is shown a second preferred embodiment of the apparatus according to the invention. The differences between first and second preferred embodiments are detailed below. In the second preferred embodiment, there are further provided a second signal receiving unit 13 including at least one microphone 11′ (two are shown) and an associated signal amplifier 12′ for amplifying signals transmitted from microphones 11′, and a timer 33 for providing real time information which in conjunction with naming rule specified by data processing unit 30 are employed by file system management in step 6 for processing filenames wherein second signal receiving unit 13 is not coplanar with respect to signal receiving unit 10 for further expanding the signal receiving area into a three dimensional (3D) space.

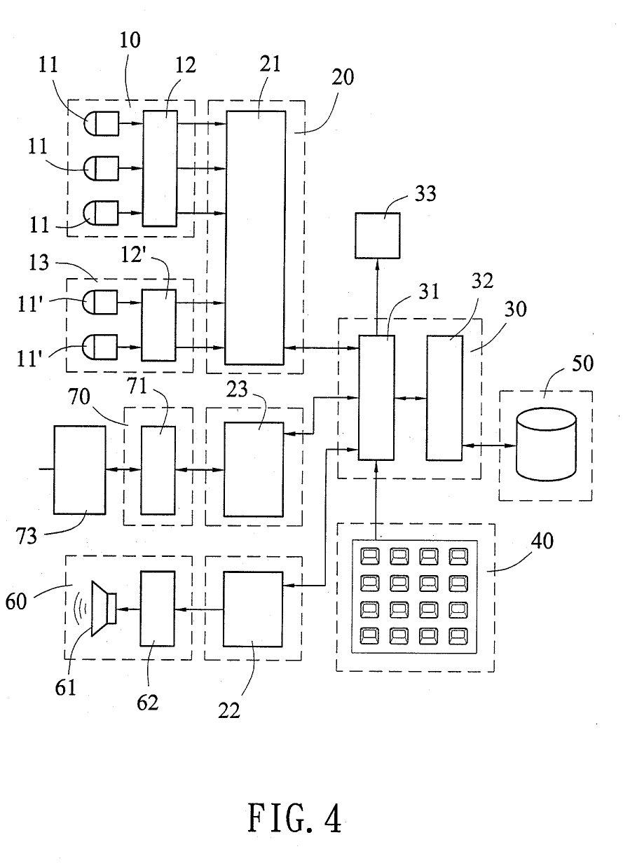

Referring to FIG. 4, there is shown a third preferred embodiment of the apparatus according to the invention. The difference between second and third preferred embodiments is detailed below. In the third preferred embodiment, CO 72 is replaced by a public branch exchange (PBX) 73 which is capable of effecting a multiple-way talking on the telephone during the meeting and/or teleconference and recording the minutes.

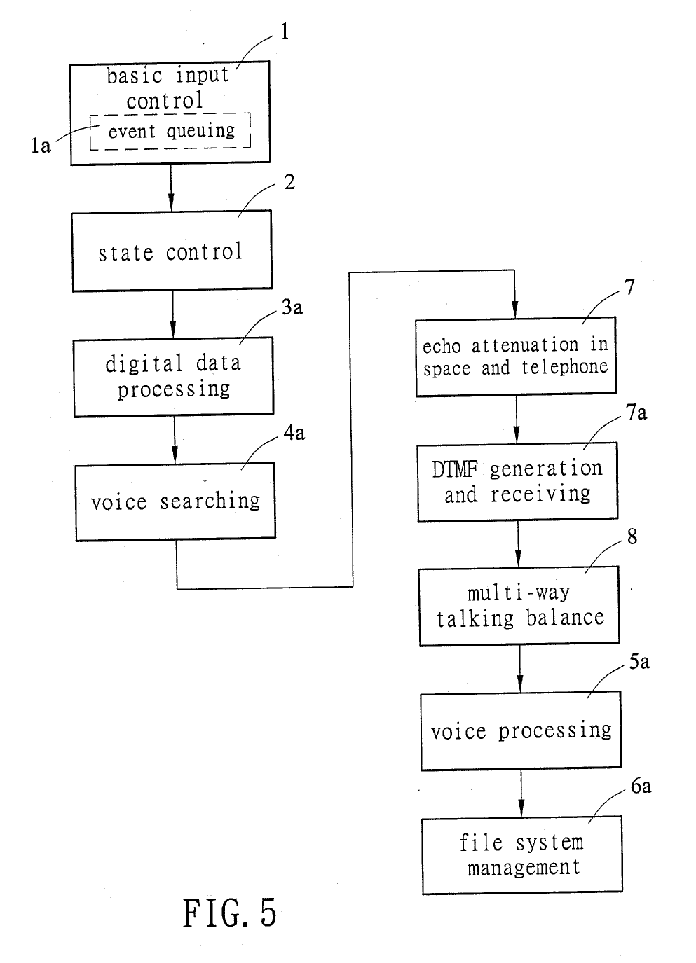

Referring to FIG. 5, there is shown a flow chart illustrating a process for recording meeting and/or teleconference according to the third preferred embodiment of the invention. The difference between the processes of first and third preferred embodiments is detailed below. In the process of the third preferred embodiment, there is further provided a step 8 of multi-way talking balance between steps 7a and 5a. In step 8, data from step 7 is received. The received data is synthesized with signals from PBX 73 and other components of the apparatus shown in FIG. 4. The synthesized signal is further processed to form into a balanced one prior to outputting to all associated components via step 3a.

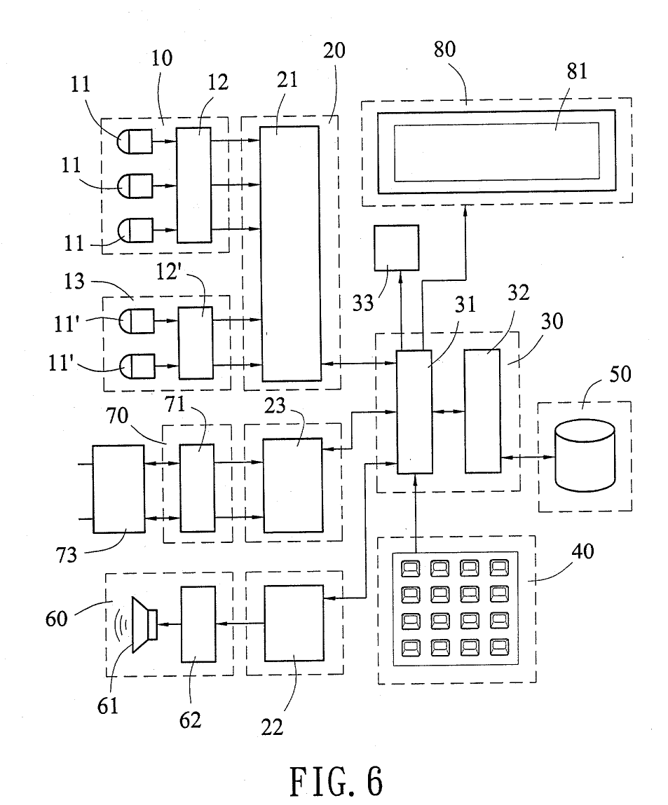

Referring to FIG. 6, there is shown a fourth preferred embodiment of the apparatus according to the invention. The difference between third and fourth preferred embodiments is detailed below. In the fourth preferred embodiment, there is further provided a display unit 80 including a display 81 controlled by logic control device 31 for receiving a control signal from central processing device 32 and displaying real time messages, time and date, etc. Display 81 may be cathode ray tube (CRT) monitor, liquid crystal display (LCD) monitor (e.g., TSDN, or thin film transistor (TFT)-LCD), or the like.

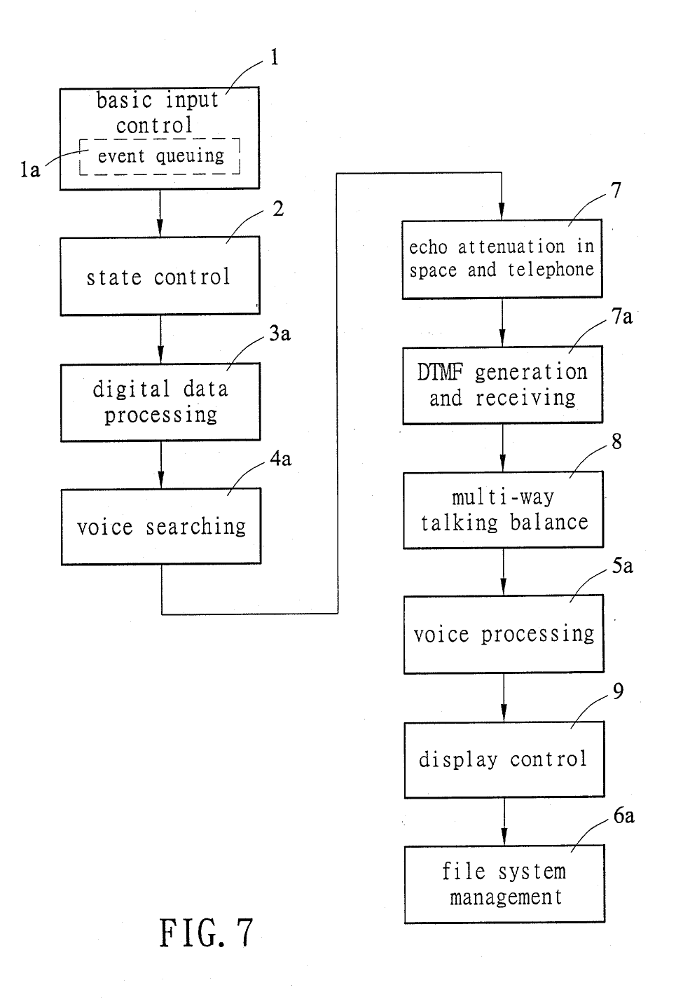

Referring to FIG. 7, there is shown a flow chart illustrating a process for recording meeting and/or teleconference according to the fourth preferred embodiment of the invention. The difference between the processes of third and fourth preferred embodiments is detailed below. In the process of the fourth preferred embodiment, there is further provided a step 9 of display control responsible for controlling a display of display unit 80 as instructed by step 2.

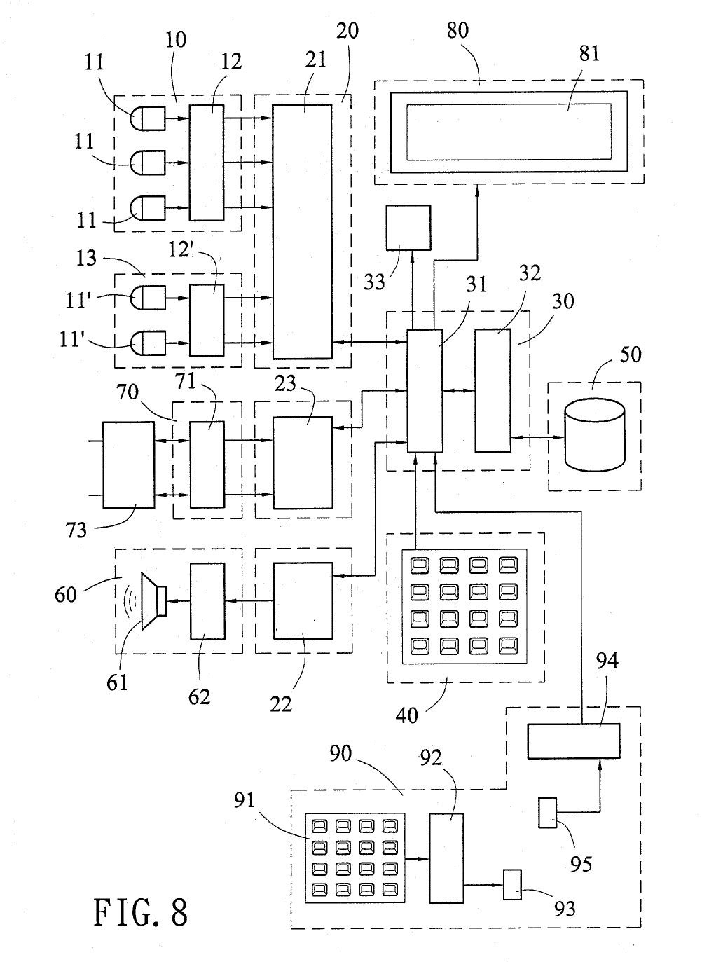

Referring to FIG. 8, there is shown a fifth preferred embodiment of the apparatus according to the invention. The difference between fourth and fifth preferred embodiments is detailed below. In the fifth preferred embodiment, there is further provided a wireless input control unit 90 for user input instructions by wireless. Wireless input control unit 90 comprises a keypad 91 for user input commands, a wireless encoder 92, a transmitter 93 both for converting commands into signal for transmission, a wireless decoder 94, and a receiver 95 both for receiving control signals which are in turn combined by logic control device 31 prior to sending to central processing device 32. This can effect a wireless control.

Other variations of the apparatus for recording meeting are contemplated in this invention. For example, CODEC unit 20 may be implemented as an I/O chip capable of performing the functions of ADC 21, DAC 22, and DAC/ADC 23. Further, logic control device 31 and central processing device 32 of data processing unit 30 may be combined on a single chip. Furthermore, signal receiving unit 10, CODEC unit 20, data processing unit 30, input control unit 40, and storage unit 50 may be combined on a single chip by means of any other semiconductor manufacturing technique.

While the invention herein disclosed has been described by means of specific embodiments, numerous modifications and variations could be made thereto by those skilled in the art without departing from the scope and spirit of the invention set forth in the claims.

What is claimed is:

1. An apparatus for recording a meeting held in a room and/or a teleconference, comprising:
a first signal receiving unit including a plurality of microphones and a first signal amplifier for amplifying signals transmitted from the microphones;
a coder/decoder (CODEC) unit including an analog-to-digital converter (ADC), a digital-to-analog converter (DAC), and a DAC/ADC;
a data processing unit including a logic control device for combining digital signals from peripheral devices into one for ease of control and a central processing device for data input/output (I/O);
an input control unit implemented as a keypad for inputting a control signal from user to the central processing device so as to perform a direction adjustment, a recording, a reading, or an inquiry;
a storage unit controlled by the central processing device in data I/O;
a speaker unit including a power amplifier for amplifying a signal outputted from the DAC and a speaker for output;
a telephone unit including a telephone interface circuit coupled to a central office (CO) so that either the digital signal from the data processing unit is converted into an analog signal in the DAC/ADC prior to transmitting to the CO through the telephone interface circuit, or the analog signal from the CO is converted into the digital signal in the DAC/ADC through the telephone interface circuit prior to transmitting to the data processing unit; and
a power source for supplying a rated voltage;
whereby voice of an individual who is making a speech during the meeting or the teleconference is located, amplified, and compressed prior to being recorded in a file of minutes, and the minutes is integrated prior to storing in the storage unit in digital format so as to improve a recording quality and facilitate a reading and an inquiry of the minutes.

2. The apparatus of claim 1, wherein the first signal receiving unit includes three coplanar microphones, each being implemented as either a capacitive or an inductive microphone; the logic control device is implemented as a field programmable gate array (FPGA) chip or other chip having the same capability; the central processing device is responsible for data I/O, the central processing device being implemented as one of digital signal processing (DSP) chip, Intel central processing unit (CPU) such as 80×86 or Pentium series, micro-controller such as 8051, 8096, or Micron, and other chip for processing data I/O; and the storage unit is a nonvolatile memory implemented as floppy disk, read-only memory (ROM), CD-RW, DVD-RAM, erasable programmable ROM (EEPROM), Flash ROM, Compact Flash, Smart Media, MultiMedia Card (MMC), Secure Digital (SD), Memory Stick, Memory Disk (MD), or other storage means in data

3. The apparatus of claim 1, further comprising a second signal receiving unit including at least one microphone and a second signal amplifier wherein the second signal receiving unit is not coplanar with respect to the first signal receiving unit.

4. The apparatus of claim 3, wherein at least one microphone of the second signal receiving unit and the second signal amplifier are combined in the second signal receiving unit; the logic control device and the central processing device are combined on a single chip; and the ADC, the DAC, and the DAC/ADC are combined on a single chip in the CODEC unit.

5. The apparatus of claim 1, further comprising a timer for providing real time information which in conjunction with a naming rule specified by the data processing unit are employed for processing filenames.

6. The apparatus of claim 1, wherein the signal receiving unit, the CODEC unit, the data processing unit, the input control unit, and the storage unit are combined on a single chip by means of one of a plurality of semiconductor manufacturing techniques.

7. The apparatus of claim 1, further comprising a display unit including a display controlled by the logic control device for receiving a control signal from the central processing device wherein the display is one of cathode ray tube (CRT) monitor and liquid crystal display (LCD) monitor such as TSDN or thin film transistor (TFT)-LCD.

8. The apparatus of claim 1, further comprising a wireless input control unit including a keypad for user input commands, a wireless encoder, a transmitter both for converting commands into a signal for transmission, a wireless decoder, and a receiver both for receiving the signals which are in turn combined by the logic control device prior to sending to the central processing device.

9. The apparatus of claim 1, further comprising a first software comprising the steps of:
(a) basic input control for receiving a control signal from the input control unit, queuing events, and converting the control signal into corresponding index of the event;
(b) state control for converting a current state of the event into the other one based on the current state;
(c) digital data processing for controlling data I/O and timing of the ADC, the DAC, and the DAC/ADC so as to further improve the recording quality;
(d) voice searching for receiving data from the signal receiving unit and the CODEC unit, guiding the received data for searching a voice source of the signal receiving unit, synthesizing signals toward the voice source, amplifying the synthesized signal a predetermined number of times, decreasing the other non-synthesized signals a predetermined number of times, and outputting the amplified signal via the step (c);
(e) echo attenuation in space and telephone for receiving the signal from either the signal receiving unit and the DAC or the telephone unit and the DAC/ADC via the step (c) prior to attenuating the signal which is in turn sent back to the step (c);
(f) dual-tone multifrequency (DTMF) generation and receiving for receiving the signal from the telephone unit and the DAC/ADC via the step (c) prior to determining whether the signal is a DTMF signal, if the determination is positive, sending a received command back to the step (b), or alternatively, receiving a control code generated in the step (b) prior to generating the DTMF signal, and sending a created data back to the telephone unit and the DAC/ADC via the step (c);
(g) voice processing is responsible for receiving the amplified digital signal from the step (c) and compressing the same, or decompressing data sent from step (f) as commanded and sending the decompressed data back to the step (c); and
(h) file system management for receiving the compressed signal, controlling an access to the compressed signal by the storage unit, and reading data from the storage unit for sending the same back to the step (g).

10. The apparatus of claim 9, wherein in the step (d) the synthesized signal is amplified three times, and the other non-synthesized signals are decreased three times.

11. The apparatus of claim 9, wherein in the step (g) a voice compression format is selected from MP3, GSM 6.10, CELP 3.2a, MELP, ACELP, TRUE SPEECH, LPC 10e, ADPCM, ALAW, or ULAW.

12. The apparatus of claim 9, wherein in the step (f) a file system is selected from FAT 12, FAT 16, Virtual FAT (VFAT), FAT 32, NT File System (NTFS), or Ext 2 (Linux).

13. An apparatus for recording a meeting held in a room and/or a teleconference, comprising:
a first signal receiving unit including a plurality of microphones and a first signal amplifier;
a coder/decoder (CODEC) unit including an analog-to-digital converter (ADC);
a data processing unit including a logic control device and a central processing device;
an input control unit implemented as a keypad for inputting a control signal from user to the central processing device;
a storage unit controlled by the central processing device in data input/output (I/O);
a digital-to-analog converter (DAC) for converting a digital signal from the central processing device into an analog signal;
a speaker unit including a power amplifier for amplifying a signal from the DAC and outputting the same;
a telephone unit including a telephone interface circuit coupled to a central office (CO);
a DAC/ADC for converting the analog signal sent from the CO into the digital signal or converting the digital signal sent from the central processing device into the analog signal;
a power source for supplying a rated voltage; and
a software comprising the steps of:
(a) basic input control for receiving a control signal from the input control unit, queuing events, and converting the control signal into corresponding index of the event;
(b) state control for converting a current state of the event into the other one based on the current state;
(c) digital data processing for controlling data I/O and timing of the ADC, the DAC, and the DAC/ADC so as to further improve the recording quality;
(d) voice searching for receiving data from the signal receiving unit and the CODEC unit, guiding the received data for searching a voice source of the signal receiving unit, synthesizing signals toward the voice source, amplifying the synthesized signal a predetermined number of times, decreasing the other non-synthesized signals a predetermined number of times, and outputting the amplified signal via the step (c);
(e) echo attenuation in space and telephone for receiving the signal from either the signal receiving unit and the DAC or the telephone unit and the DAC/ADC via the step (c) prior to attenuating the signal which is in turn sent back to the step (c);
(f) dual-tone multifrequency (DTMF) generation and receiving for receiving the signal from the telephone unit and the DAC/ADC via the step (c) prior to determining whether the signal is a DTMF signal, if the determination is positive, sending a received command back to the step (b), or alternatively, receiving a control code generated in the step (b) prior to generating the DTMF signal, and sending a created data back to the telephone unit and the DAC/ADC via the step (c);
(g) voice processing is responsible for receiving the amplified digital signal from the step (c) and compressing the same, or decompressing data sent from step (f) as commanded and sending the decompressed data back to the step (c); and
(h) file system management for receiving the compressed signal, controlling an access to the compressed signal by the storage unit, and reading data from the storage unit for sending the same back to the step (g).

14. The apparatus of claim 13, further comprising a second signal receiving unit including at least one microphone and a second signal amplifier wherein the second signal receiving unit is not coplanar with respect to the first signal receiving unit.

15. The apparatus of claim 13, wherein at least one microphone of the second signal receiving unit and the second signal amplifier are combined in the second signal receiving unit; the logic control device and the central processing device are combined on a single chip; and the ADC, the DAC, and the DAC/ADC are combined on a single chip in the CODEC unit.

16. The apparatus of claim 13, further comprising a timer for providing real time information which in conjunction with a naming rule specified by the data processing unit are employed for processing filenames.

17. The apparatus of claim 13, wherein the signal receiving unit, the CODEC unit, the data processing unit, the input control unit, and the storage unit are combined on a single chip by means of one of a plurality of semiconductor manufacturing techniques.

18. The apparatus of claim 13, wherein the telephone unit further comprises a public branch exchange (PBX) for effecting a multiple-way talking on a telephone during the meeting or the teleconference, further comprising the step (i) of multi-way talking balance between the steps (f) and (g) for receiving data from the step (f), synthesizing the received data with the signals from the PBX and other components of the apparatus, processing the synthesized signal to form into a balanced signal, and outputting the balanced signal to all associated components of the apparatus via the step (c).

19. An apparatus for recording a meeting held in a room and/or a teleconference, comprising:
a first signal receiving unit including a plurality of microphones and a first signal amplifier;
a coder/decoder (CODEC) unit including an analog-to-digital converter (ADC);
a data processing unit including a logic control device and a central processing device;
a timer for providing real time information being controlled by the logic control device;
an input control unit implemented as a keypad for inputting a control signal from user to the central processing device;
a storage unit controlled by the central processing device in data input/output (I/O);
a digital-to-analog converter (DAC) for converting a digital signal from the central processing device into an analog signal;
a speaker unit including a power amplifier for amplifying a signal from the DAC and outputting the same;
a telephone unit including a telephone interface circuit coupled to a public branch exchange (PBX) for effecting a multiple-way talking on a telephone during the meeting or the teleconference;
a DAC/ADC for converting the analog signal sent from the PBX into the digital signal or converting the digital signal sent from the central processing device into the analog signal;
a display unit controlled by the logic control device for receiving a control signal from the central processing device;
a power source for supplying a rated voltage; and
a software comprising the steps of:
(a) basic input control for receiving a control signal from the input control unit, queuing events, and converting the control signal into corresponding index of the event;
(b) state control for converting a current state of the event into the other one based on the current state;
(c) digital data processing for controlling data I/O and timing of the ADC, the DAC, and the DAC/ADC so as to further improve the recording quality;
(d) voice searching for receiving data from the signal receiving unit and the CODEC unit, guiding the received data for searching a voice source of the signal receiving unit, synthesizing signals toward the voice source, amplifying the synthesized signal a predetermined number of times, decreasing the other non-synthesized signals a predetermined number of times, and outputting the amplified signal via the step (c);
(e) echo attenuation in space and telephone for receiving the signal from either the signal receiving unit and the DAC or the telephone unit and the DAC/ADC via the step (c) prior to attenuating the signal which is in turn sent back to the step (c);
(f) dual-tone multifrequency (DTMF) generation and receiving for receiving the signal from the telephone unit and the DAC/ADC via the step (c) prior to determining whether the signal is a DTMF signal, if the determination is positive, sending a received command back to the step (b), or alternatively, receiving a control code generated in the step (b) prior to generating the DTMF signal, and sending a created data back to the telephone unit and the DAC/ADC via the step
(f1) multi-way talking balance for receiving data from the step (f), synthesizing the received data with the signals from the PBX and other components of the apparatus, processing the synthesized signal to form into a balanced signal, and outputting the balanced signal to all associated components of the apparatus via the step (c);
(g) voice processing is responsible for receiving the amplified digital signal from the step (c) and compressing the same, or decompressing data sent from step (f) as commanded and sending the decompressed data back to the step (c);
(g1) display control for controlling a display of the display unit as instructed by the step (b); and
(h) file system management for receiving the compressed signal from the step (g), providing real time information by the timer wherein the real time information is in conjunction with a naming rule specified by the data processing unit for processing filenames, and controlling an access to the compressed signal by the storage unit.

20. The apparatus of claim 19, further comprising a second signal receiving unit including at least one microphone and a second signal amplifier wherein the second signal receiving unit is not coplanar with respect to the first signal receiving unit.
